(19) United States
(12) Patent Application Publication
(10) Pub. No.: US 2005/0234905 A1
(43) Pub. Date: Oct. 20, 2005

(54) Methods and apparatuses for capturing and storing content related to an event

(76) Inventors: Sean Christopher Endler, San Francisco, CA (US); Joseph Steven Herres, Seattle, WA (US); Ippei Tambata, San Francisco, CA (US)

Correspondence Address: Valley Oak Law, 5655 Silver Creek Valley Road, #106, San Jose, CA, 95138, US

(21) Appl. No.: 10/821,099

(22) Filed: Apr. 7, 2004

(51) Int. Cl. G06F 7/00

(52) U.S. Cl. 707/5

(57) ABSTRACT

In one embodiment, the methods and apparatuses detect an event; search for an event profile corresponding to the event; detect content and description information corresponding to the content; and associate the content with the event based on the description information and the event profile.

### FIELD OF THE INVENTION

The present invention relates generally to capturing and storing content and, more particularly, to capturing and storing content related to an event.

### BACKGROUND

There has been a proliferation of portable electronic device utilized by both business and personal users. These portable electronic devices aid the user in tracking of their schedules, communicating with others via voice, and communicating with others via electronic messages. These portable electronic devices include cellular phones, personal digital assistants (PDAs), and the like.

For some users, these portable electronic devices are indispensable for organizing their calendars and communicating with others both for their professional and personal lives. For example, in some instances, the portable electronic device is used to set up a meeting between another person by communicating via either voice signals or electronic messages. In some instances, the portable electronic device is also used to store the meeting time and location on the user's calendar. In some instances, the portable electronic device also reminds the user of the scheduled meeting and directs the user to the meeting location based on the user's current location.

### SUMMARY

In one embodiment, the methods and apparatuses detect an event; search for an event profile corresponding to the event; detect content and description information corresponding to the content; and associate the content with the event based on the description information and the event profile.

### BRIEF DESCRIPTION OF THE DRAWINGS

The accompanying drawings, which are incorporated in and constitute a part of this specification, illustrate and explain one embodiment of the methods and apparatuses for capturing and storing content related to an event. In the drawings,

FIG. 1 is a diagram illustrating an environment within which the methods and apparatuses for capturing and storing content related to an event are implemented;

FIG. 2 is a simplified block diagram illustrating one embodiment in which the methods and apparatuses for capturing and storing content related to an event are implemented;

FIG. 3 is a simplified block diagram illustrating a system, consistent with one embodiment of the methods and apparatuses capturing and storing content related to an event;

FIG. 4A is an exemplary record for use with the methods and apparatuses for capturing and storing content related to an event;

FIG. 4B is an exemplary content for use with the methods and apparatuses for capturing and storing content related to an event;

FIG. 5 is a flow diagram consistent with one embodiment of the methods and apparatuses for capturing and storing content related to an event;

FIG. 6 is a flow diagram consistent with one embodiment of the methods and apparatuses for capturing and storing content related to an event;

FIG. 7 is a flow diagram consistent with one embodiment of the methods and apparatuses for capturing and storing content related to an event;

FIG. 8 is a flow diagram consistent with one embodiment of the methods and apparatuses for capturing and storing content related to an event; and

FIG. 9 is an exemplary screen shot consistent with one embodiment of the methods and apparatuses for capturing and storing content related to an event.

### DETAILED DESCRIPTION

The following detailed description of the methods and apparatuses for capturing and storing content related to an event refers to the accompanying drawings. The detailed description is not intended to limit the methods and apparatuses for capturing and storing content related to an event. Instead, the scope of the methods and apparatuses for capturing and storing content related to an event are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, and a device capable of receiving/transmitting an electronic message.

References to an “event” or “meeting” include a congregation of more than one person.

References to “content” includes photographs, electronic images, video, audio, graphics, and documents.

In one embodiment, the methods and apparatuses for capturing and storing content related to an event automatically associates the content with the event based on the description information of the content and the event information. In one embodiment, the description information of the content includes the location while capturing the content, the time and date of capturing the content, and the author of the content. In one embodiment, the event information includes the location of the event, the date and time of the event, the duration of the event, and the participants of the event. In one embodiment, the description information is compared with the event information to determine which event, if any, the content is associated with.

In one embodiment, the methods and apparatuses for capturing and storing content related to an event allows a participant of the event to access the content associated with the event.

In one embodiment, a record is associated with each event and contains the event information.

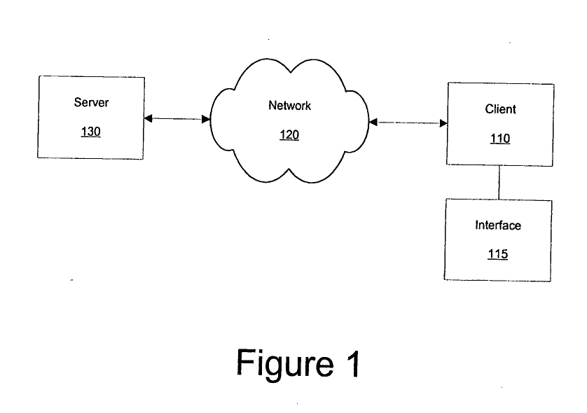

FIG. 1 is a diagram illustrating an environment within which the methods and apparatuses for capturing and storing content related to an event are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of capturing and storing content related to an event below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

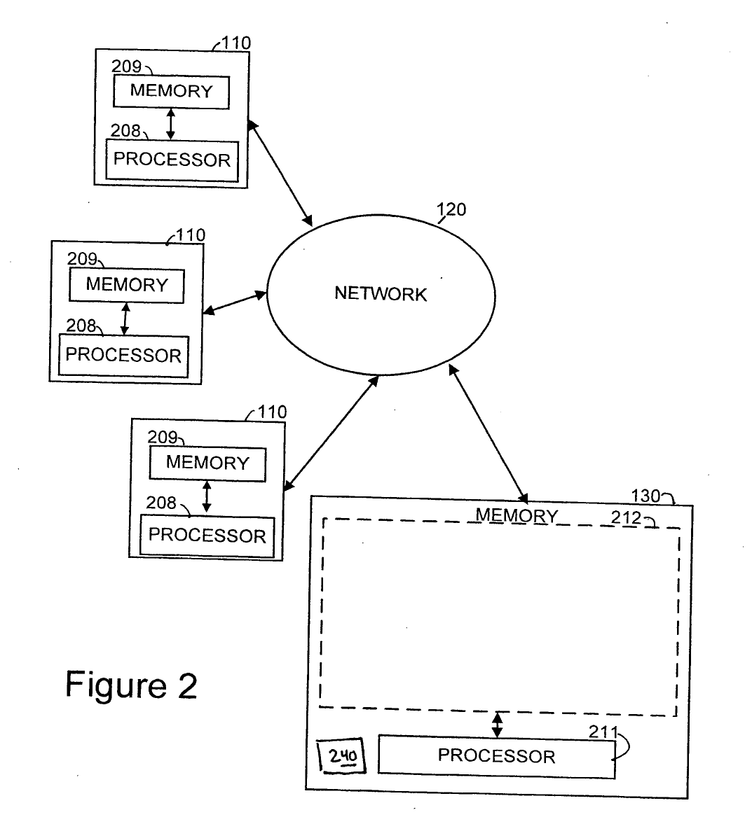

FIG. 2 is a simplified diagram illustrating an exemplary architecture in which the methods and apparatuses for capturing and storing content related to an event are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for capturing and storing content related to an event. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on capturing and storing content related to an event as determined using embodiments described below.

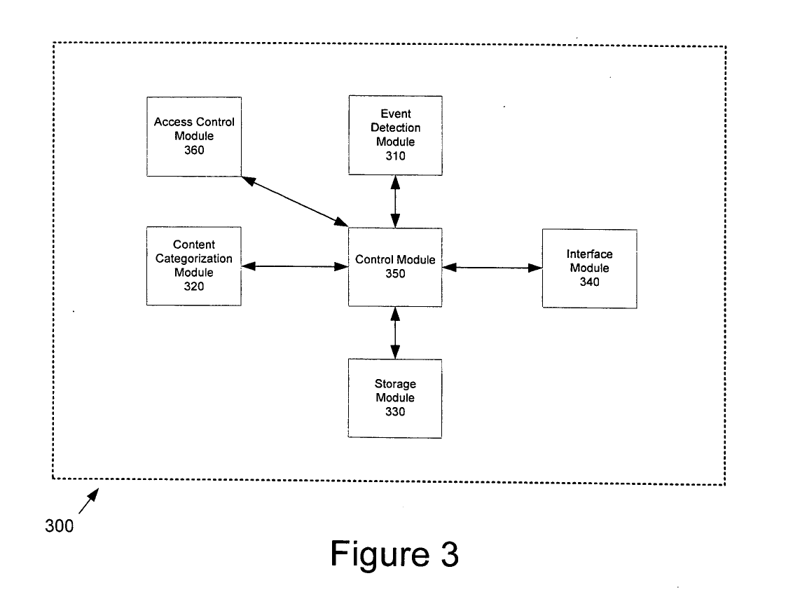

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes an event detection module 310, a content categorization detection module 320, a storage module 330, an interface module 340, a control module 350, and an access control module 360.

In one embodiment, the control module 350 communicates with the event detection module 310, the content categorization detection module 320, a storage module 330, the interface module 340, and the access control module 360. In one embodiment, the control module 350 coordinates tasks, requests, and communications between the event detection module 310, the content categorization detection module 320, a storage module 330, the interface module 340, and the access control module 360.

In one embodiment, the event detection module 310 detects an event that is scheduled. In one embodiment, the event is a meeting among more than one user at an event location, at an event time, for an event duration, and with event participants. In one example of an event, the event location is at Joe's Java at an event time of 10:00 PM on Sep. 12, 2004 for the event duration of 2 hours with specific event participants.

In one embodiment, the event is scheduled in advance of the actual event and is detected by the system 300 as the event is scheduled. In another embodiment, as the event is occurring, the system 300 detects the event.

In one embodiment, the device detection module 310 receives a signal from an electronic device informing the system 300 of the event. In one embodiment, the signal includes additional information regarding the event such as event location, event time, event duration, and event participants

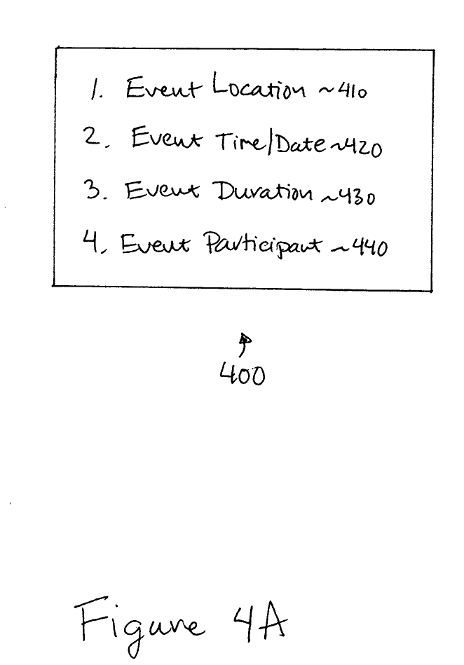

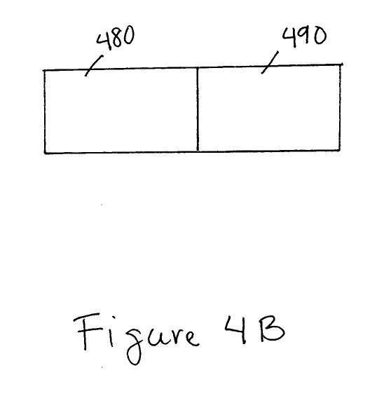

In one embodiment, by identifying the event, the device detection module 310 utilizes additional information associated with the particular event. Additional information corresponding with the particular event is shown in an exemplary record illustrated in FIG. 4A. In one embodiment, this additional information is utilized by the system 300.

In one embodiment, the content categorization module 320 determines which event the content should be categorized with. In one embodiment, the content categorization module 320 detects the content and description information related to the content. In one embodiment, the content is a photograph. In another embodiment, the content is video content, audio content, a document, a graphic, and the like. An exemplary embodiment of content information 480 and description information 490 is shown in FIG. 4B.

In one embodiment, the description information describes the particular content such as the date/time the content was captured, location where the content was captured, the unique device that captured the content, and the logged in participant who captured the content. In one embodiment, the date/time is recorded by a time stamp when the content is recorded by a device. For example, a time stamp function within a digital camera is capable of capturing the time and date when capturing an electronic image. In one embodiment, the location where the content is captured is also detected and recorded by the device. For example, a digital camera with a location detection component such as a global positioning system (GPS) is capable of detecting the location of the digital camera when capturing an electronic image. In one embodiment, the identity of the device is recorded when capturing content. For example, each device has a unique serial number that identifies the particular device and is recorded when capturing the electronic image.

In one embodiment, the storage module 330 stores a record including information associated with a particular event. An exemplary embodiment of the information contained within the record associated with an event is illustrated in FIG. 4A. In another embodiment, the storage module 330 stores content that is transmitted to the system from one of the electronic device. In yet another embodiment, the storage module 330 stores content description information that is related to the stored content.

In one embodiment, the interface module 340 receives a signal from one of the electronic devices 110 indicating an event and/or content with content description information that is received by the system 300. In another embodiment, the interface module 340 receives a signal from one of the electronic devices 110 asking permission to view the stored content. In yet another embodiment, the interface module 340 transmits the stored content to one of the electronic devices 110.

In one embodiment, the access control module 360 selectively transmits the content stored within the storage module 330 to an electronic device based on the user requesting the content. For example, if the user requesting the content is authorized to view the content, then the access control module 360 makes the content available to the user. In one embodiment, the user is authorized to view the content, if the user is one of the participants at the event that corresponds with the content.

In another embodiment, the access control module 360 selectively allows an electronic device to access the content stored within the storage module 330.

The system 300 in FIG. 3 is shown for exemplary purposes and is merely one embodiment of the methods and apparatuses for capturing and storing content related to an event. Additional modules may be added to the system 300 without departing from the scope of the methods and apparatuses for capturing and storing content related to an event. Similarly, modules may be combined or deleted without departing from the scope of the methods and apparatuses for capturing and storing content related to an event.

FIG. 4A illustrates an exemplary record 400 identifying attributes of a particular event for use with the system 300. In one embodiment, there are multiple records such that each record 400 is associated with a particular event. In one embodiment, the record 400 includes an event location field 410, an event time/date field 420, an event duration field 430, and an event participant field 440.

In one embodiment, the event location field 410 uniquely identifies the location of the event. In one embodiment, the address of the location for the event is utilized. In another embodiment, the name of the location for the event is utilized, and the name of the location is associated with the street address. For example, if the event is located at Joe's Café, then the street address for Joe's Café is utilized. In another example, the name Joe's Café is utilized for the event location and the street address for Joe's Café is cross referenced in a separate database.

In one embodiment, the event time/date field 420 uniquely identifies the date and time of the event. For example, the event time/date field indicates a date and time of the event such as Feb. 27, 2004 at 4 PM.

In one embodiment, the event duration field 430 identifies the length of time scheduled for the event.

In one embodiment, the event participant field 440 identifies the participants that are attending the event. The event participant field 440 lists the participants of the event. In one embodiment, each unique device is utilized by a single participant. In one example, the identity of the participant is determined by the device.

In another embodiment, when there are multiple users corresponding to each device, a password is utilized to identify the particular participant.

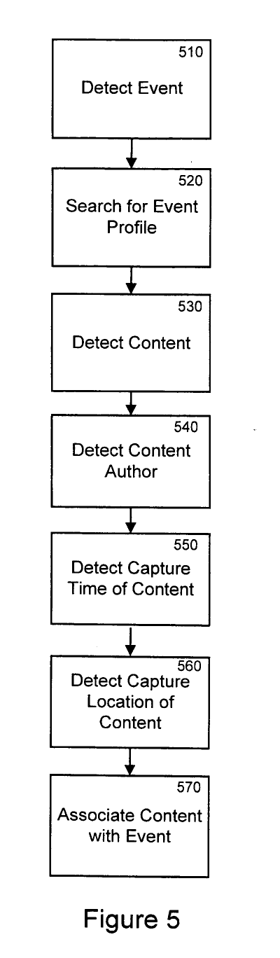

The flow diagrams as depicted in FIGS. 5, 6, 7, and 8 are one embodiment of the methods and apparatuses for capturing and storing content related to an event. The blocks within the flow diagrams can be performed in a different sequence without departing from the spirit of the methods and apparatuses for capturing and storing content related to an event. Further, blocks can be deleted, added, or combined without departing from the spirit of the methods and apparatuses for capturing and storing content related to an event.

The flow diagram in FIG. 5 illustrates categorizing content with an event based on multiple factors according to one embodiment of the invention.

In Block 510, an event is detected. In one embodiment, the event includes business meetings, social gatherings, activity groups, and the like. In one embodiment, a single event is detected. In another embodiment, multiple events are detected.

In Block 520, information related to the event (event profile) is searched. In one embodiment, the event profile is stored within the storage module 330. In one embodiment, the event profile includes the event location, event time/date, event duration, and event participants. An exemplary event profile record is shown in FIG. 4A.

In Block 530, content is detected. In one embodiment, the content includes a digital photograph. In another embodiment, the content includes items such as video, audio, graphical, and textual resources.

In Block 540, the author of the content is detected. For example, the content detected in the Block 530 is a digital photograph captured by an author. In one embodiment, the author is identified by the author's name. In another embodiment, the author is identified by the particular digital camera utilized to capture the digital photograph.

In Block 550, the time and date corresponding to the content is detected. In one embodiment, the time and data is recorded as the content is captured. For example, a time stamp function within a digital camera records the time and date that the image was captured.

In Block 560, the location of the content's capture is detected. In one embodiment, as the content is captured, the location of this operation is recorded. For example, as a digital image is captured by a digital camera, a positioning device is utilized to record the location information as the digital image is captured. In one embodiment, the positioning device utilizes a global positioning system. In another embodiment, the positioning device utilizes a cellular transmission network.

In one embodiment, the author, the time/date, and the location detected within the Blocks 540, 550, and 560 are stored within the description information 490 as shown in FIG. 4B.

In Block 570, the content is associated with a particular event. In one embodiment, the content is associated with the particular event based on a match between the author of the content and one of the event participants as listed in the event profile. If the author of the content is not one of the participants of the event, then the content is most likely not related to the event in question.

In another embodiment, the content is associated with the particular event based on a match between the capture time and date of the content and the event time/date as listed in the event profile. Further, the event duration as listed in the event profile provides a range of time that the event occurred. If the capture time and date of the content does not fall within the event based on the event time/date and the event duration, then the content is most likely not related to the event in question. In one embodiment, different time ranges are utilized to prevent minor variations in location information from excluding content from being associated with the correct event.

In another embodiment, the content is associated with the particular event based on a match between the capture location of the content and the location of the event as listed in the event profile. If the capture location of the content is not within the location of the event, then the content is most likely not related to the event in question. In one embodiment, different location ranges are utilized to prevent minor variations in location information from excluding content from being associated with the correct event. Further, the content may be captured at the event while being located outside the event location.

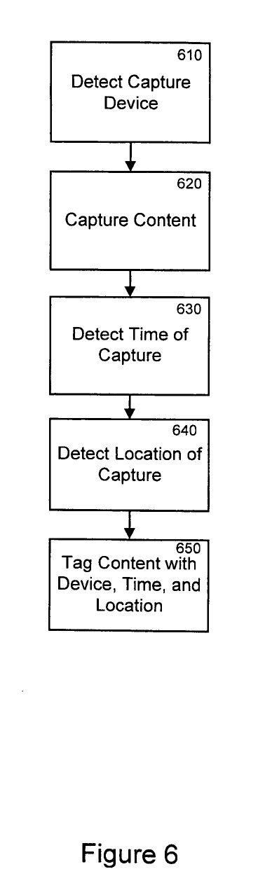

The flow diagram in FIG. 6 illustrates capturing content with description information according to one embodiment of the invention.

In Block 610, a capture device is detected. In one embodiment, the capture device is a digital camera. In another embodiment, the capture device is a video camera, an audio recorder, a scanner, and the like.

In one embodiment, the author is detected based on the capture device. For example, an author can be associated with a particular capture device, and the particular capture device is detected through a device serial number.

In Block 620, the content is captured by the capture device. In one embodiment, the content is shown as content information 480 in FIG. 4B.

In Block 630, the time and date is detected corresponding to when the content is captured. In one embodiment, the time and data is recorded simultaneously as the content is captured. For example, a time stamp function within a digital camera records the time and date that the image was captured.

In Block 640, the location of the content's capture is detected. In one embodiment, as the content is captured, the location of this operation is recorded.

In Block 650, the author, the time/date, and the location detected within the Blocks 6100, 630, and 640 are stored within the description information 490 as shown in FIG. 4B.

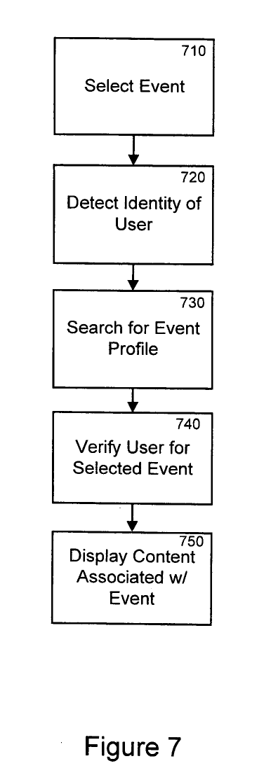

The flow diagram in FIG. 7 illustrates viewing the content associated with an event according to one embodiment of the invention.

In Block 710, a particular event is selected by a user. In one embodiment, a plurality of events is stored within the storage module 330. Further, each event is represented by an event profile and stored as a record.

In Block 720, the identity of the user is detected. In one embodiment, the electronic device utilized by the user identifies the user's identity. In another embodiment, a password is utilized to uniquely identify the user.

In Block 730, the event profile associated with the selected event is searched.

In Block 740, the user's clearance to view the content associated with the selected event is verified. In one embodiment, only the participants of the selected event are authorized to view the content associated with the selected event. Based on the event profile for the selected event, the user is checked against the participant of the selected event.

In Block 750, the content associated with the selected event is searched. In one embodiment, the content includes audio, video, still images, graphics, text, and the like. If the user is one of the participants of the selected event, then the content is displayed to the user.

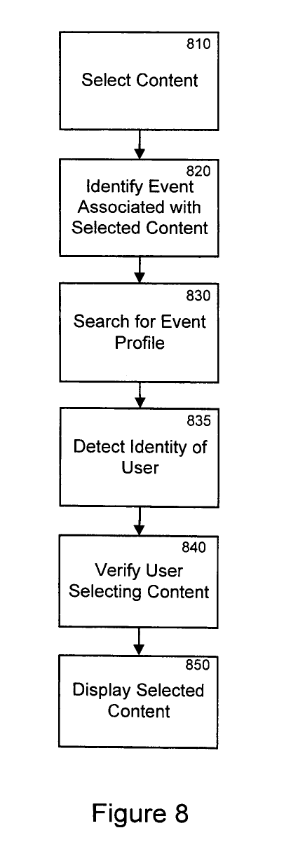

The flow diagram in FIG. 8 illustrates viewing the content associated with an event according to one embodiment of the invention.

In Block 810, a particular content is selected by a user. In one embodiment, the content includes audio, video, still images, graphics, text, and the like.

In Block 820, an event that is associated with the particular content is identified. In one embodiment, the particular content is associated with one of a plurality of events that is stored within the storage module 330. Further, each event is represented by an event profile and stored as a record.

In Block 830, the event profile associated with the selected event is searched.

In Block 835, the identity of the user is detected. In one embodiment, the electronic device utilized by the user identifies the user's identity. In another embodiment, a password is utilized to uniquely identify the user.

In Block 840, the user's clearance to view the content associated with the event is verified. In one embodiment, only the participants of the event are authorized to view the content associated with the event. Based on the event profile for the event, the user is checked against the participant of the selected event.

In Block 850, the content associated with the selected event is searched. In one embodiment, the content includes audio, video, still images, graphics, text, and the like. If the user is one of the participants of the selected event, then the content is displayed to the user.

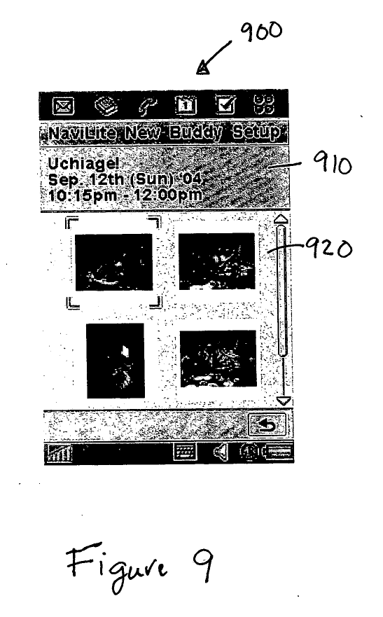

FIG. 9 illustrates a screen shot 900 that displays information relating to content corresponding to an event. An event information display 910 shows information related to the event such as title of the event, date and time of the event, and location of the event. Further, content 920 associated with the event is also shown.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
detecting an event;
searching for an event profile corresponding to the event;
detecting content and description information corresponding to the content; and
associating the content with the event based on the description information and the event profile.

2. The method according to claim 1 further comprising matching the description information with the event profile.

3. The method according to claim 1 wherein the event profile includes an event location.

4. The method according to claim 1 wherein the event profile includes an event time.

5. The method according to claim 1 wherein the event profile includes an event duration.

6. The method according to claim 1 wherein the event profile includes a listing of event participants.

7. The method according to claim 1 wherein the description information includes a capture location.

8. The method according to claim 1 wherein the description information includes a time.

9. The method according to claim 1 wherein the description information includes an author.

10. The method according to claim 1 wherein the content is a digital image.

11. The method according to claim 1 wherein the content is one of a video media, an audio media, a textual media, and a graphical media.

12. The method according to claim 1 further comprising storing the event profile.

13. The method according to claim 1 further comprising storing the description information with the content.

14. A system comprising:
means for detecting an event;
means for searching for an event profile corresponding to the event;
means for detecting content and description information corresponding to the content; and
means for associating the content with the event based on the description information and the event profile.

15. A method comprising:
receiving a request to access content from a user;
searching for an event profile corresponding to the content;
matching the content with the event profile; and
displaying the content based on the user and the event profile.

16. The method according to claim 15 further comprising searching for description information corresponding to the content.

17. The method according to claim 16 wherein the user is an author listed in the description information.

18. The method according to claim 15 wherein the user is a participant within the event profile.

19. The method according to claim 15 further comprising confirming an identity of the user.

20. A system, comprising:
an interface module to receive content and description information corresponding to the content;
a storage module to store a record containing an event profile describing an event; and
a content categorization module for matching the content with the event based on the event profile and the description information.

21. The system according to claim 20 further comprising an event detection module to detect the event.

22. The system according to claim 20 wherein the storage module stores the description information and the content.

23. The system according to claim 20 further comprising an access control module to selectively allow a user to view the content.

24. The system according to claim 23 wherein the access control module allows the user to view the content when the user is a participant listed in the event profile associated with the event.

25. A computer-readable medium having computer executable instructions for performing a method comprising:
receiving a request to access content from a user;
searching for an event profile corresponding to the content;
matching the content with the event profile; and
displaying the content based on the user and the event profile.
